(19) United States
(12) Patent Application Publication
(10) Pub. No.: US 2026/0179193 A1
(43) Pub. Date: Jun. 25, 2026

(54) IMAGE PROCESSING

(71) Applicant: BEIJING BAIDU NETCOM SCIENCE TECHNOLOGY CO., LTD., BEIJING (CN)

(72) Inventor: Feiyang LIU, BEIJING (CN)

(73) Assignee: BEIJING BAIDU NETCOM SCIENCE TECHNOLOGY CO., LTD., Beijing (CN)

(21) Appl. No.: 18/990,855

(22) Filed: Dec. 20, 2024

(30) Foreign Application Priority Data
Sep. 10, 2024 (CN) 202411267041.7

(51) Int. Cl. G06T 5/70; G06T 5/73; H04N 19/86

(52) U.S. Cl. CPC G06T 5/70; G06T 5/73; G06T 2207/10016; G06T 2207/10024; H04N 19/86

(57) ABSTRACT

An image processing method, an apparatus, a device, and a medium are provided, which relate to the technical field of image processing, specifically to the technical field of image denoising, image enhancement and the like. The image processing method comprises: obtaining an image to be processed, where the image to be processed comprises a plurality of pixels; determining a surface curvature of each pixel of the plurality of pixels; determining, based on a first predetermined curvature requirement, an isolated point noise pixel in the plurality of pixels; and denoising the isolated point noise pixel.

### CROSS-REFERENCES TO RELATED APPLICATIONS

This application claims priority to Chinese Patent Application No. 202411267041.7, filed Sep. 10, 2024, the contents of which are hereby incorporated by reference in their entirety for all purposes.

### TECHNICAL FIELD

The present disclosure relates to the technical field of image processing, specifically to the technical field of image denoising, image enhancement, and the like, which can be applied to scenarios such as autonomous driving, and in particular relates to an image processing method, an image processing apparatus, an electronic device, a computer-readable storage medium, and a computer program product.

### BACKGROUND

Performing pre-processing enhancement on a low-quality image is an effective method to improve the subjective experience for the image. By denoising the low-quality image, the subjective quality of the image can be effectively enhanced, resulting in a clearer intuitive experience for the viewer.

The methods described in this section are not necessarily methods that have been previously conceived or employed. Unless otherwise indicated, it should not be assumed that any method described in this section is considered to be the prior art only due to its inclusion in this section. Similarly, the problems mentioned in this section should not be assumed to be recognized in any prior art unless otherwise indicated.

### SUMMARY

The present disclosure provides an image processing method, an image processing apparatus, an electronic device, a computer readable storage medium, and a computer program product.

According to an aspect of the present disclosure, there is provided an image processing method, including: obtaining an image to be processed, where the image to be processed includes a plurality of pixels; determining a surface curvature of each pixel of the plurality of pixels; determining, based on a first predetermined curvature requirement, an isolated point noise pixel in the plurality of pixels; and denoising the isolated point noise pixel.

According to an aspect of the present disclosure, there is provided an image processing apparatus, including: an obtaining unit configured to obtain an image to be processed, and the image to be processed includes a plurality of pixels; a surface curvature determination unit configured to determine a surface curvature of each pixel of the plurality of pixels; an isolated point noise pixel

determination unit configured to determine pixels which meet a first predetermined curvature requirement in the plurality of pixels to be isolated point noise pixels; and a denoising unit configured to denoise the isolated point noise pixels.

According to another aspect of the present disclosure, there is provided an electronic device, including: one or more processors; and a memory storing one or more programs configured to be executed by the one or more processors, the one or more programs including instructions for: obtaining an image to be processed, where the image to be processed comprises a plurality of pixels; determining a surface curvature of each pixel of the plurality of pixels; determining, based on a first predetermined curvature requirement, an isolated point noise pixel in the plurality of pixels; and denoising the isolated point noise pixel.

According to another aspect of the present disclosure, there is provided a non-transient computer-readable storage medium storing one or more programs, the one or more programs comprising instructions, which when executed by one or more processors of an electronic device, cause the electronic device to: obtain an image to be processed, where the image to be processed comprises a plurality of pixels; determine a surface curvature of each pixel of the plurality of pixels; determine, based on a first predetermined curvature requirement, an isolated point noise pixel in the plurality of pixels; and denoise the isolated point noise pixel.

According to another aspect of the present disclosure, there is provided a computer program product, including a computer program, wherein the computer program implements the aforementioned methods when executed by a processor.

According to one or more embodiments of the present disclosure, effective enhancement of the subjective quality of an image is achieved by determining surface curvatures of a plurality of pixels in an image to be processed, determining isolated point noises in the plurality of pixels based on a predetermined curvature requirement, and then denoising these isolated point noises.

It should be understood that the content described in this section is not intended to identify key or important features of the embodiments of the present disclosure, nor is it intended to limit the scope of the present disclosure. Other features of the present disclosure will become readily understood from the following description.

### BRIEF DESCRIPTION OF THE DRAWINGS

The drawings illustrate embodiments and constitute a part of the specification, and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 is a schematic diagram illustrating an example system in which various methods described herein can be implemented according to embodiments of the present disclosure.

FIG. 2 illustrates a flowchart of an image processing method according to example embodiments of the present disclosure;

FIG. 3 illustrates a flowchart of an image processing method according to example embodiments of the present disclosure;

FIG. 4 illustrates a flowchart for enhancing a non-isolated point noise pixel based on the surface curvature of the non-isolated point noise pixel in the plurality of pixels according to example embodiments of the present disclosure;

FIG. 5 illustrates a flowchart for enhancing a non-isolated point noise pixel based on a sharpening intensity according to example embodiments of the present disclosure;

FIG. 6 illustrates a structural block diagram of an apparatus for image processing according to example embodiments of the present disclosure; and

FIG. 7 illustrates a structural block diagram of an example electronic device that can be used to implement embodiments of the present disclosure.

### DETAILED DESCRIPTION OF THE EMBODIMENTS

The example embodiments of the present disclosure are described below in conjunction with the accompanying drawings, including various details of the embodiments of the present disclosure to facilitate understanding, and they should be considered as example only. Therefore, one of ordinary skill in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first”, “second” and the like are used to describe various elements and are not intended to limit the positional relationship, timing relationship, or importance relationship of these elements, and such terms are only used to distinguish one element from another. In some examples, the first element and the second element may refer to the same instance of the element, while in some cases they may also refer to different instances based on the description of the context.

The terminology used in the description of the various examples in this disclosure is for the purpose of describing particular examples only and is not intended to be limiting. Unless the context clearly indicates otherwise, if the number of elements is not specifically defined, the element may be one or more. In addition, the terms “and/or” used in the present disclosure encompass any one of the listed items and all possible combinations thereof.

In the related art, the means of denoising an image is simple and the effect is poor.

To address the above problems, the present disclosure achieves effective enhancement of the subjective quality of an image by determining surface curvatures of a plurality of pixels in an image to be processed and determining isolated point noises in the plurality of pixels based on a predetermined curvature requirement, and then denoising these isolated point noises.

The embodiments of the present disclosure will be described in detail below with reference to the accompanying drawings.

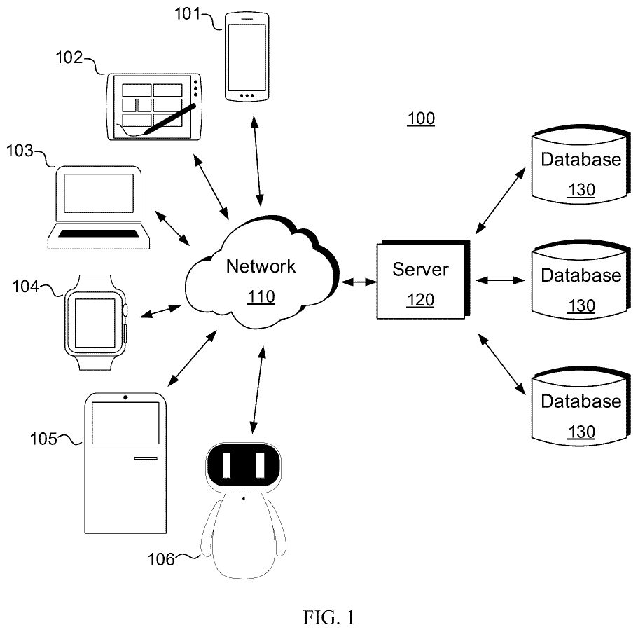

FIG. 1 illustrates a schematic diagram of an example system 100 in which various methods and apparatuses described herein may be implemented in accordance with embodiments of the present disclosure. Referring to FIG. 1, the system 100 includes one or more client devices 101, 102, 103, 104, 105, and 106, a server 120, and one or more communication networks 110 that couple one or more client devices to the server 120. The client devices 101, 102, 103, 104, 105, and 106 may be configured to execute one or more applications.

In embodiments of the present disclosure, the server 120 may run one or more services or software applications that enable execution of methods of the present disclosure.

In some embodiments, the server 120 may also provide other services or software applications, which may include non-virtual environments and virtual environments. In some embodiments, these services may be provided as web-based services or cloud services, such as to the user of the client devices 101, 102, 103, 104, 105, and/or 106 under a Software as a Service (SaaS) model.

In the configuration shown in FIG. 1, the server 120 may include one or more components that implement functions performed by the server 120. These components may include software components, hardware components, or a combination thereof that are executable by one or more processors. A user operating the client devices 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client devices 101, 102, 103, 104, 105, and/or 106 to perform human-machine interaction. The client devices may provide an interface that enables the user of the client devices to interact with the client devices. The client devices may also output information to the user via the interface. Although FIG. 1 depicts only six client devices, those skilled in the art will be able to understand that the present disclosure may support any number of client devices.

The client devices 101, 102, 103, 104, 105, and/or 106 may include various types of computer devices, such as portable handheld devices, general-purpose computers, such as personal computers and laptop computers, workstation computers, wearable devices, smart screen devices, self-service terminal devices, service robots, gaming systems, thin clients, various messaging devices, sensors, or other sensing devices, and the like. These computer devices may run various types and versions of software applications and operating systems, such as Microsoft Windows, Apple IOS, Unix-like operating systems, Linux or Linux-like operating systems (e.g., Google Chrome OS); or include various mobile operating systems, such as Microsoft Windows Mobile OS, iOS, Windows Phone, Android. The portable handhold devices may include cellular telephones, smart phones, tablet computers, personal digital assistants (PDA), and the like. The wearable devices may include head-mounted displays, such as smart glasses, and other devices. The gaming systems may include various handhold gaming devices, Internet-enabled gaming devices, and the like. The client devices can perform various different applications, such as various applications related to the Internet, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (for example, Bluetooth, WIFI), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage device that may be virtualized to maintain virtual storage devices of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including a HTTP server, an FTP server, a CGI server, a JAVA server, a database server, etc.

In some implementations, the server 120 may include one or more applications to analyze and merge data feeds and/or event updates received from the user of the client devices 101, 102, 103, 104, 105, and/or 106. The server 130 may also include one or more applications to display the data feeds and/or the ground truth-time events via one or more display devices of the client devices 101, 102, 103, 104, 105, and/or 106.

In some embodiments, the server 120 may be a server of a distributed system, or a server incorporating a block chain. The server 120 may also be a cloud server, or an intelligent cloud computing server or an intelligent cloud host with an artificial intelligence technology. The cloud server is a host product in a cloud computing service system to overcome the defects of management difficulty and weak service expandability exiting in a traditional physical host and virtual private server (VPS) service.

The system 100 may also include one or more databases 130. In certain embodiments, these databases may be used to store data and other information. For example, one or more of the databases 130 may be used to store information such as audio files and video files. The databases 130 may reside in various locations. For example, the database used by the server 120 may be local to the server 120, or may be remote to the server 120 and may communicate with the server 120 via a network-based or dedicated connection. The databases 130 may be of different types. In some embodiments, the database used by the server 120 may be, for example, a relational database. One or more of these databases may store, update, and retrieve data to and from the database in response to a command.

In some embodiments, one or more of the databases 130 may also be used by an application to store application data. The databases used by the application may be different types of databases, such as a key-value repository, an object repository, or a conventional repository supported by a file system.

The system 100 of FIG. 1 may be configured and operated in various ways to enable application of various methods and apparatuses described according to the present disclosure.

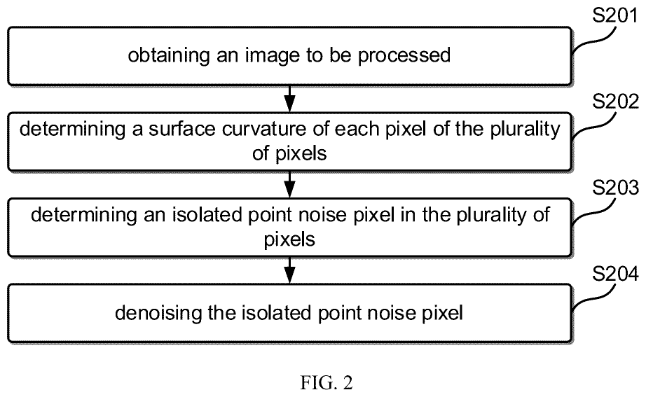

According to an aspect of the present disclosure, there is provided an image processing method. As shown in FIG. 2, the image processing method includes: step S201, obtaining an image to be processed, where the image to be processed includes a plurality of pixels; step S202, determining a surface curvature of each pixel of the plurality of pixels; step S203, determining, based on a first predetermined curvature requirement, an isolated point noise pixel in the plurality of pixels; and step S204, denoising the isolated point noise pixel.

As a result, effective enhancement of the subjective quality of an image is achieved by determining surface curvatures of a plurality of pixels in an image to be processed and determining an isolated point noise pixel in the plurality of pixels based on a predetermined curvature requirement, and then denoising the isolated point noise pixel.

In some embodiments, a plurality of isolated point noise pixels could be determined in step S203, and these insolated point noise pixels could be denoised in step S204.

The image processing method provided in the present disclosure can be used to process encoded image frames in a video. A pre-processing enhancement of low-quality encoded content is an effective method for enhancing the subjective experience of an encoded video. In existing video enhancement techniques, sharpening is a relatively simple and effective means of enhancement, which can effectively highlight textures and edges in a video, resulting in a clearer intuitive experience for the viewer. However, concurrent with sharpening, the noise may also be amplified to a certain extent, resulting in a serious subjective experience degradation. By processing the encoded image frames using the image processing method of the present disclosure and then further enhancing the processed image using means such as sharpening, the above problems can be effectively avoided, thereby obtaining an image with better subjective quality.

In the process of video encoding and decoding, the basic process is as follows: in an encoder, a frame is divided into blocks, a prediction block of the current block is generated using intra prediction or inter prediction for the current block, a residual block is obtained by subtracting the prediction block from the original block of the current block, the residual block is transformed and quantized to obtain a quantization coefficient matrix, and the quantization coefficient matrix is entropy encoded and output to a bitstream. In a decoder, a prediction block of the current block is generated using intra prediction or inter prediction for the current block, on the other hand, a bitstream is decoded to obtain a quantization coefficient matrix, the quantization coefficient matrix is inverse quantized and inverse transformed to obtain a residual block, and the prediction block and the residual block are summed to obtain a reconstructed block. The reconstructed blocks form a reconstructed image, and a decoded image is obtained by loop filtering the reconstructed image based on the image or based on the blocks. The encoder also requires similar operations as the decoder to obtain a decoded image. The decoded image can be used as a reference frame of inter prediction for subsequent frames. The block division information determined by the encoder, mode information such as prediction, transformation, quantization, entropy encoding, loop filtering and the like, or parameter information, if necessary, needs to be output to the bitstream; and then the decoder determines, by parsing and analyzing based on the information already available, the block division information, mode information such as prediction, transformation, quantization, entropy encoding, loop filtering and the like, or parameter information, which is the same as the encoder, thereby ensuring that the decoded image obtained by the encoder and the decoded image obtained by the decoder are the same. The decoded image obtained by the encoder is usually called a reconstructed image. When predicting, the current block can be divided into prediction units, and when transforming, the current block can be divided into transformation units, and the prediction units and transformation units can be divided differently. The above is the basic process of the video encoder and decoder under a block-based hybrid coding framework, and some modules or steps of the framework or the process may be optimized as the technology develops, and embodiments of the present application are applicable to the basic process under the block-based hybrid coding framework, but are not limited to the framework and the process.

Currently, the common video codec standards adopt a block-based hybrid coding framework. Each frame in a video image is partitioned into square LCUs of the same size (e.g., 128×128, 64×64, etc.), and each LCU may further be partitioned into rectangular CUs according to a rule; and the CUs may further be partitioned into smaller PUs, TUs, and the like. Specifically, this coding framework may include steps such as Prediction, Transform, Quantization, Entropy Coding, and In Loop Filter. Wherein, the Prediction can further be divided into Intra Prediction and Inter Prediction, and the inter prediction can include Motion Estimation and Motion Compensation. Since there exists a strong correlation between neighbouring pixels within a frame of the video image, the use of intra prediction in video codec technologies can eliminate spatial redundancy between neighbouring pixels; however, since there also exists a strong similarity between neighbouring frames of the video image, the use of inter prediction in video codec technologies eliminates temporal redundancy between neighbouring frames, thereby improving the efficiency of coding and decoding.

A video is composed of a plurality of images. In order to make the video look smooth, the video per second contains dozens or even hundreds of frames of images, for example, 24 frames per second, 30 frames per second, 50 frames per second, 60 frames per second, or 120 frames per second. Therefore, there are more temporal redundancies in the video, or in other words, there are more temporal correlations in the video. Inter-prediction utilizes this temporal correlation to improve compression efficiency. Inter-prediction often uses “motion” to utilize temporal correlation. A very simple “motion” model is that an object is located at a certain position on the image corresponding to a certain moment, and after a certain amount of time, it is translated to another position on the image corresponding to the current moment. This is the more basic and commonly used translation motion in video coding and decoding. Inter-prediction uses motion information to represent “motion”. The basic motion information contains information of reference frame and information of MV; wherein the reference frame can also be interpreted as a reference picture. The codec determines the reference frame/reference picture based on the information of the reference frame/reference picture, and determines the coordinate of the reference block based on the information of the MV and the coordinate of the current block. In the reference picture, the reference block is determined using the coordinate of the reference block. Using the determined reference block as the prediction block is the most basic prediction method of inter prediction.

In some embodiments, in step S201, a frame of coded image source may be read as the image to be processed.

In embodiments of the present disclosure, the video to be audio-video synchronization tested may be read using a video reading tool, and the video is decoded by the video reading tool to obtain a video segment of a target length, and the video segment is audio-video synchronization tested to obtain an audio-video synchronization test result of the video segment.

Wherein, the video decoding formats include but are not limited to: (1) H.264/AVC (Advanced Video Coding), the video decoder is libx264; (2) H.265/HEVC (High Efficiency Video Coding, the video decoder is libx265; (3) VP8 (Video Coding Format by Google), the video decoder is libvpx; (4) VP9 (Successor to VP8), the video decoder is libvpx-vp9; (5) AV1 (AOMedia Video 1), the video decoder is libaom-av1; (6) MPEG-2 (Moving Picture Experts Group Phase 2), the video decoder is mpeg2video; (7) MPEG-4 (Moving Picture Experts Group Phase 4), the video decoder is mpeg4; (8) Theora (Free and Open Video Codec), the video decoder is libtheora; (9) ProRes (Apple ProRes), the video decoder is prores; (10) DNxHD (Digital Nonlinear Extensible High Definition), the video decoder is dnxhd; (11) WMV (Windows Media Video), the video decoder is wmv2; (12) FLV1 (Flash Video), the video decoder is flv; (13) MJPEG (Motion JPEG), the video decoder is mjpeg.

Wherein, the audio decoding formats include but are not limited to: (1) AAC (Advanced Audio Coding), the audio decoder is aac; (2) MP3 (MPEG-1 Audio Layer 3), the audio decoder is libmp3lame; (3) Vorbis (Ogg Vorbis), the audio decoder is libvorbis; (4) Opus (Audio Codec), the audio decoder is libopus; (5) FLAC (Free Lossless Audio Codec), the audio decoder is flac; (6) ALAC (Apple Lossless Audio Code), the audio decoder is alac; (7) AC3 (Audio Codec 3), the audio decoder is ac3; (8) WMA (Windows Media Audio), the audio decoder is wmav2; (9) WAV (Waveform Audio File Format), the audio decoder is a built-in WAV decoder; (10) AMR (Adaptive Multi-Rate) encoder, the audio decoder is libopencore_amrnb (NB), libopencore_amrwb (WB); (11) PCM (Pulse Code Modulation), the audio decoder is pcm_s16le, pcm_s24le, and the like.

It can be understood that the image processing methods provided in the present disclosure may also be used to process other images, which are not limited herein.

In step S202, a surface curvature of each pixel in the image to be processed can be determined. The surface curvature of a pixel can be used to describe the variation of the pixel value around a certain pixel in the image. In the present disclosure, the surface curvature of a pixel refers to the surface curvature corresponding to each pixel on the surface consisting of pixel values of a plurality of pixels in a space with pixel coordinates as the x-axis and γ-axis and pixel values as the z-axis. Specifically, surface curvature refers to the curvature of a surface at this point in a three-dimensional space, where the coordinate positions (x, y) of pixels serve as the two-dimensional planar coordinates and the pixel values (the gray values or the color values) of the pixels serves as the third dimension (z-axis). The curvature can provide information about the local morphology of the image, which facilitates to identify which regions are flat and which are steep.

For calculating the surface curvature of each pixel, the image first needs to be analyzed within a local window (e.g., a 3×3 or 5×5 pixel neighborhood). In some embodiments, the respective Gaussian curvature, mean curvature, minimum curvature, and/or other curvatures of the plurality of pixels may be calculated as the surface curvature of the corresponding pixel.

In some embodiments, the Gaussian curvature can be determined by calculating the product of principal curvatures of the surface (the maximum curvature and minimum curvature at certain point in two principal directions that are perpendicular to each other). The mean curvature can be the average of two principal curvatures of the surface, which is typically used to indicate the local smoothness of the image. The minimum curvature can be obtained by calculating the local difference for a center pixel and its eight neighbouring pixels.

In an example embodiment, the minimum curvature may be calculated by the following formula:

$${d}_{1} = ( U ( i - 1 , j ) + U ( i + 1 , j ) / 2 - U ( i , j )$$

$${d}_{2} = ( U ( i , j - 1 ) + U ( i , j + 1 ) ) / 2 - U ( i , j )$$

$${d}_{3} = ( U ( i - 1 , j - 1 ) + U ( i + 1 , j + 1 ) / 2 - U ( i , j )$$

$${d}_{4} = ( U ( i - 1 , j + 1 ) + U ( i + 1 , j - 1 ) / 2 - U ( i , j )$$

$${d}_{5} = U ( i - 1 , j ) + U ( i , j - 1 ) - U ( i - 1 , j - 1 ) - U ( i , j )$$

$${d}_{6} = U ( i - 1 , j ) + U ( i , j + 1 ) - U ( i - 1 , j + 1 ) - U ( i , j )$$

$${d}_{7} = U ( i , j - 1 ) + U ( i + 1 , j ) - U ( i + 1 , j - 1 ) - U ( i , j )$$

$${d}_{8} = U ( i , j + 1 ) + U ( i + 1 , j ) - U ( i + 1 , j + 1 ) - U ( i , j )$$

to determine the surface curvature dₘ of pixel (i, j), such that |dₘ|=min {|dₖ|, k=1, . . . , 8}.

where (i, j) is the coordinate of the center pixel and U (⋅,⋅) are the pixel values of the corresponding neighbouring pixels. The above d₁ and d₂ reflect the second-order difference of the center pixel in both horizontal and vertical directions, d₃ and d₄ reflect the second-order difference of the center pixel in two diagonal directions, and d₅-d₈ reflect the local differences of the center pixel within the upper-left neighborhood, upper-right neighborhood, lower-left neighborhood, and lower-right neighborhood, respectively. The meaning of |dₘ|=min {|dₖ|, k=1, . . . , 8} is to determine the surface curvature dₘ (i.e., the minimum curvature) of pixel (i, j) to be the value (absolute value) of the item with the smallest absolute value in the above d₁-d₈.

In step S203, pixels, which meet a first predetermined curvature requirement, in the plurality of pixels can be determined as an isolated point noise pixel. The first predetermined curvature requirement can be a predetermined curvature range.

According to some embodiments, the first predetermined curvature requirement may include the surface curvature of the corresponding pixel being greater than a predetermined surface curvature threshold. By identifying pixels with greater surface curvature as an isolated point noise pixel, the subjective quality of the denoised image can be effectively improved.

In addition, it has been observed that an isolated point noise pixel usually has greater curvature in each direction, whereas a texture edge in the image content may have greater curvature only in some directions, therefore utilizing the above minimum curvature and setting a corresponding predetermined surface curvature threshold makes it possible to effectively identify isolated point noises in the image, thereby improving the subjective quality of the processed image.

The predetermined surface curvature threshold can be set as required. In an example embodiment, the predetermined surface curvature threshold can be set to 5.

In step S204, the surface curvature of the pixel may be further utilized to denoise the isolated point noise pixel.

According to some embodiments, denoising the isolated point noise pixel may include: compensating the pixel value of the isolated point noise pixel, such that the surface curvature of the compensated isolated point noise pixel meets a second predetermined curvature requirement.

Thereby, in the above manner, the isolated point noises in the image can be effectively removed, and the denoised image is made smoother.

In some embodiments, the compensation of the pixel value of the isolated point noise pixel can be implemented by adjusting the pixel value of the isolated point noise pixel. Specifically, a search algorithm or other method can be used to determine a pixel value which enables the surface curvature of the compensated isolated point noise pixel to meet the above second predetermined curvature requirement. According to some embodiments, the second predetermined curvature requirement may include the surface curvature of the compensated isolated point noise pixel being zero. By reducing the surface curvature of the isolated point noise pixel to zero, sudden pixel value change caused by the isolated point noise in the image can be removed to the greatest extent. Specifically, reducing the surface curvature of the isolated point noise pixel to zero makes the surface between the compensated isolated point noise pixel and the neighboring pixels to be smooth. In addition, in some embodiments, after denoising the image to be processed (especially the coded image source in the video), a picture quality enhancement operation such as sharpening can further be performed on the image, but at the same time of sharpening, the noise is also amplified to a certain extent, resulting in a serious subjective experience degradation. Therefore, the above approach can avoid the amplification of noise in the sharpening process to the greatest extent.

In some embodiments, a search algorithm or other method can be used to determine the pixel value of the compensated isolated point noise pixel, such that the surface curvature of the compensated isolated point noise pixel being zero.

In some embodiments of the related art, for achieving subjective quality enhancement of the image, sharpening is usually performed using the same parameters for the entire frame picture, but such approach lacks perception of the content. To solve the above problem, the present disclosure proposes an image processing method, in which an isolated point noise pixel in an image are identified and denoised using surface curvatures of pixels, while adaptive enhancement is performed for the remaining non-isolated point noise pixels using the surface curvatures. In other words, the above approach determines whether each pixel is a meaningful texture edge or an isolated point noise by the surface curvature, and then denoises the isolated point noise pixel and enhances the non-isolated point noise pixel (the texture edge). In this way, the subjective quality of the image can be improved as a whole.

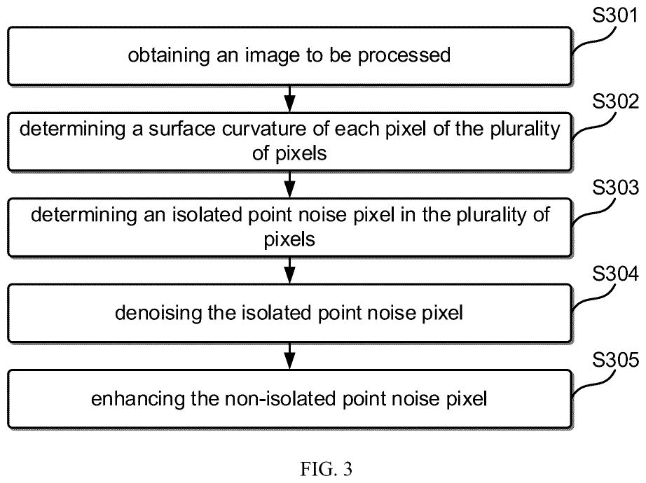

According to some embodiments, the image processing method may further include: determining a non-isolated point noise pixel in the plurality of pixels. As shown in FIG. 3, the image processing method may further include: step S305, enhancing the non-isolated point noise pixel based on the surface curvatures of the non-isolated point noise pixel. The operation of steps S301-S304 in FIG. 3 can refer to the foregoing description of steps S201-S204 in FIG. 2, and details are not described herein again.

The non-isolated point noise pixel can, for example, be a pixel not satisfying a first predetermined curvature requirement, or any other pixels except the isolated point noise pixels. Furthermore, a plurality of non-isolated point noise pixels may be determined, and being enhanced in step S305. In step S305, parameters for sharpening can be determined using the surface curvature of the non-isolated point noise pixel, thereby implementing adaptive processing of the image enhancement.

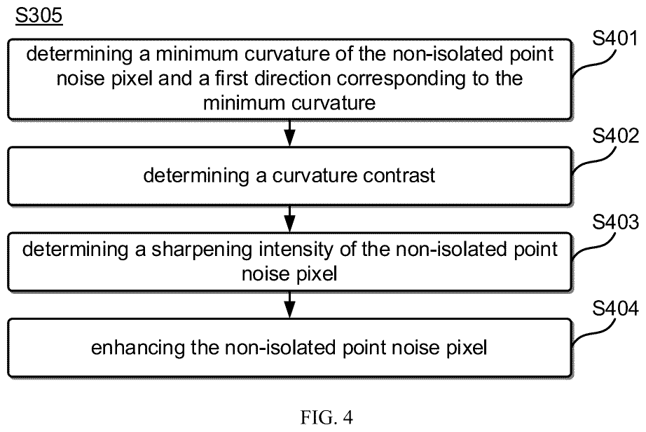

According to some embodiments, as shown in FIG. 4, in step S305, enhancing the non-isolated point noise pixel based on the surface curvatures of the non-isolated point noise pixel of the plurality of pixels may include: step S401, determining a minimum curvature of the non-isolated point noise pixel and a first direction corresponding to the minimum curvature; step S402, determining a curvature contrast based on the curvature of the non-isolated point noise pixel in a second direction perpendicular to the first direction and the minimum curvature; step S403, determining a sharpening intensity of the non-isolated point noise pixel based on the curvature contrast, where the sharpening intensity is positively correlated with the curvature contrast; and step S404, enhancing the non-isolated point noise pixel based on the sharpening intensity.

As a result, by determining, based on the curvatures in the minimum curvature direction and the perpendicular direction, the curvature contrast to determine the strength of the edge and calculating the corresponding sharpening intensity, adaptive sharpening is implemented to ensure the maintenance of the edge and the suppression of the black/white edge effect.

In some embodiments, in step S401, surface curvatures of the non-isolated point noise pixel in a plurality of directions can be calculated, and the one with the smallest absolute value therein is determined, i.e., the minimum curvature. In addition, the direction in which the minimum curvature is located can be determined, i.e., the first direction.

In some embodiments, in step S402, the ratio of the curvature (absolute value) in the perpendicular direction (the second direction) of the minimum curvature direction (the first direction) of the non-isolated point noise pixel and the minimum curvature (absolute value) can be used as the curvature contrast c. It can be understood that the curvature contrast, which can used to judge the strength of the edge, can be obtained in other ways based on the curvature in the perpendicular direction of the minimum curvature direction of the non-isolated point noise pixel and the minimum curvature, which is not limited herein.

In some embodiments, in step S403, the curvature contrast can be mapped to a sharpening intensity. The sharpening intensity can be represented as s=A/(1+e−c), where c is the curvature contrast and A is a scaling factor, the value of A can be adjusted according to the sharpening requirement, and the range of the sharpening intensity s is (0, A). In an example embodiment, A can be taken as 1 or 4.

In some embodiments, in step S404, the non-isolated point noise pixel can be enhanced based on the sharpening intensity.

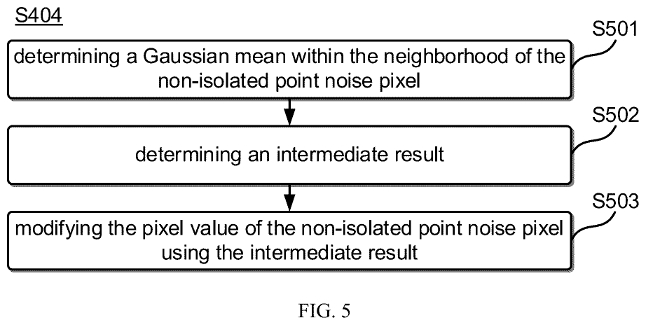

According to some embodiments, as shown in FIG. 5, in step S404, enhancing the non-isolated point noise pixel based on the sharpening intensity may include: step S501, determining a Gaussian mean within the neighborhood of the non-isolated point noise pixel; step S502, determining an intermediate result based on the sharpening intensity and the difference between the pixel value of the non-isolated point noise pixel and the Gaussian mean, where the intermediate result is positively correlated with the difference and the intermediate result is positively correlated with the sharpening intensity; and step S503, modifying the pixel value of the non-isolated point noise pixel using the intermediate result, and truncating the modified pixel value to an effective value range.

As a result, in the above manner, the effect of adaptive sharpening can be further enhanced, thereby improving the subjective quality of the processed image.

In some embodiments, in step S501, a Gaussian mean value p′ within the neighborhood of the non-isolated point noise pixel may be determined. The specific range of the neighborhood of the non-isolated point noise pixel may be determined as required.

In some embodiments, in step S502, the product of the difference (p−p′) between the pixel value p of the non-isolated point noise pixel and the Gaussian mean and the sharpening intensity s may be determined as an intermediate result.

In some embodiments, in step S503, the intermediate result may be summed with the pixel value of the non-isolated point noise pixel to enable the modification of the pixel value of the non-isolated point noise pixel, to obtain p+(p−p′)*s. Further, it may be truncated to an effective value range according to the bit depth of the image (e.g., an 8-bit image), to obtain an enhanced pixel value.

According to some embodiments, the plurality of pixels may each include a plurality of color components. The plurality of color classifications may include three color components in the YUV color model, i.e., luminance component Y, chroma component U, and chroma component V, or include three color components in the Lab color model, i.e., luminance component L, color component a, and color component b, or include three color components in the RGB color model, i.e., Red R, Green G, and Blue B, or other color components in other color models, which will not be repeated herein.

For the image to be processed having a plurality of color components, in step S202, surface curvatures may be determined for different color components respectively. That is, the surface curvature of each pixel of the plurality of pixels may include a plurality of surface curvatures of each pixel of the plurality of pixels corresponding to the plurality of color components respectively. The surface curvature corresponding to each color component refers to the surface curvature corresponding to each pixel on a surface consisting of the values of that color component of the plurality of pixels in a space with the pixel coordinates as the x-axis and the y-axis, and with the values of that color component as the z-axis. Accordingly, the first predetermined curvature requirement may include a plurality of first predetermined curvature sub-requirements corresponding to the plurality of color components, respectively.

In some embodiments, in step S203, determining pixels which meet a first predetermined curvature requirement in the plurality of pixels as isolated point noise pixel may include: for each pixel of the plurality of pixels, in response to determining that at least one color component of the pixel meets at least one corresponding first predetermined curvature sub-requirement, determining the pixel to be an isolated point noise pixel.

As a result, in the above manner, the isolated point noise pixel can be determined and denoised for different color components, respectively, and different predetermined curvature requirements can be set for different color components, thereby enabling more refined denoising.

According to some embodiments, in step S204, denoising the isolated point noise pixel may include: for each color component of the isolated point noise pixel, in response to determining that the color component meets the corresponding first predetermined curvature sub-requirement, compensating the value of the color component, such that the surface curvature corresponding to the compensated color component meets the second predetermined curvature sub-requirement corresponding to the color component.

As a result, in the above manner, compensation can be performed for each color component, respectively, thereby enabling more refined denoising.

In some embodiments, in step S204, it may be determined, for each color component (e.g., the luminance component Y, the chroma component U, and the chroma component V), whether the color component meets the corresponding first predetermined curvature sub-requirement. For example, it may be determined whether the surface curvature of the isolated point noise pixel at the luminance component Y meets the first predetermined curvature sub-requirement corresponding to the luminance component Y. If it meets the requirement, then it indicates that the value of the isolated point noise pixel at the luminance classification Y needs to be compensated. Compensation can be performed in the manner described above, that is, the value of the isolated point noise pixel at the luminance classification Y can be adjusted such that the surface curvature of the compensated isolated point noise pixel at the luminance component Y meets the second predetermined curvature sub-requirement corresponding to the luminance component Y. If none of the surface curvatures of the isolated point noise pixel at the plurality of color components meets the corresponding first predetermined curvature sub-requirement, the above compensation operation can be performed on these color components respectively.

In some embodiments, the second predetermined curvature sub-requirement corresponding to each color component each can include the surface curvature corresponding to the compensated color component being zero. That is, denoising the isolated point noise may include adjusting the values of all the color components, which do not meet the corresponding first predetermined curvature sub-requirement, of the isolated point noise pixel, such that the surface curvatures corresponding to these adjusted color classifications all being zero.

According to some embodiments, for each color component of the plurality of color components, the first predetermined curvature sub-requirement corresponding to the color component may include the surface curvature of the corresponding pixel corresponding to the color component being greater than the predetermined surface curvature threshold corresponding to the color component. That is, the corresponding predetermined surface curvature threshold can be set for each color component, separately. For example, for the YUV color space, Y denotes luminance, and U and V are used to distinguish different colors. Considering that the difference in brightness between a noise point pixel and the neighbouring non-noise point pixel and the difference in color between the noise point pixel and the neighbouring non-noise point pixel may be different, different predetermined surface curvature thresholds may be set for these three.

As a result, more refined denoising is enabled by setting different predetermined surface curvature thresholds for different color components.

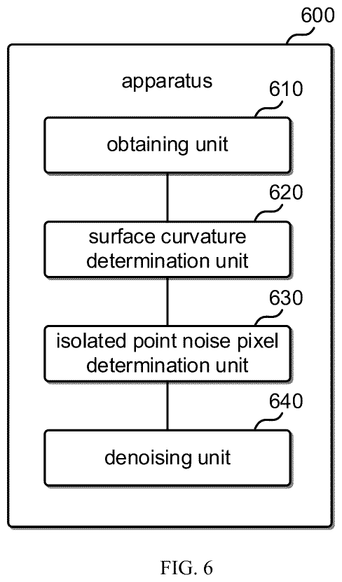

According to another aspect of the present disclosure, there is provided an image processing apparatus. As shown in FIG. 6, the apparatus 600 includes: an obtaining unit 610 configured to obtain an image to be processed, and the image to be processed includes a plurality of pixels; a surface curvature determination unit 620 configured to determine a surface curvature of each pixel of the plurality of pixels; an isolated point noise pixel determination unit 630 configured to determine pixels, which meet a first predetermined curvature requirement, in the plurality of pixels to be isolated point noise pixels; and a denoising unit 640 configured to denoise the isolated point noise pixels.

It can be understood that the operations and effects of the obtaining unit 610—the denoising unit 640 in the apparatus 600 can be described with reference to the description of steps S201-S204 in FIG. 2 above, and will not be repeated herein.

According to some embodiments, the denoising unit may be configured to compensate the pixel value of the isolated point noise pixel such that the surface curvature of the compensated isolated point noise pixel meets a second predetermined curvature requirement.

According to some embodiments, the first predetermined curvature requirement may include the surface curvature of the corresponding pixel being greater than a predetermined surface curvature threshold, and the second predetermined curvature requirement may include the surface curvature of the compensated isolated point noise pixel being zero.

According to some embodiments, the image processing apparatus may further include: an enhancement unit configured to enhance the non-isolated point noise pixels based on the surface curvatures of the non-isolated point noise pixels in the plurality of pixels.

According to some embodiments, the enhancement unit may include: a minimum curvature determination unit configured to determine a minimum curvature of the non-isolated point noise pixel and a first direction in which the minimum curvature is located; a curvature contrast determination sub-unit configured to determine a curvature contrast based on the curvature of the non-isolated point noise pixel in a second direction perpendicular to the first direction and the minimum curvature; a sharpening intensity determination sub-unit configured to determine a sharpening intensity of the non-isolated point noise pixel based on the curvature contrast, where the sharpening intensity is positively correlated with the curvature contrast; and an enhancement sub-unit configured to enhance the non-isolated point noise pixel based on the sharpening intensity.

According to some embodiments, the enhancement sub-unit may include: a Gaussian mean determination sub-unit configured to determine a Gaussian mean value within the neighborhood of the non-isolated point noise pixel; an intermediate result determination sub-unit configured to determine an intermediate result based on the difference between the pixel value of the non-isolated point noise pixel and the Gaussian mean value and the sharpening intensity, where the intermediate result is positively correlated with the difference value and the intermediate result is positively correlated with the sharpening intensity; and a modification sub-unit configured to modify the pixel value of the non-isolated point noise pixel using the intermediate result and truncate the modified pixel value to an effective value range.

According to some embodiments, the plurality of pixels may each include a plurality of color components, the surface curvature of each pixel of the plurality of pixels may include a plurality of surface curvatures of each pixel of the plurality of pixels corresponding to the plurality of color components respectively, and the first predetermined curvature requirement may include a plurality of first predetermined curvature sub-requirements corresponding to the plurality of color components respectively. The isolated point noise pixel determination unit may be configured to, for each pixel of the plurality of pixels, in response to determining that at least one color component of the pixel meets at least one corresponding first predetermined curvature sub-requirement, determine the pixel to be an isolated point noise pixel.

According to some embodiments, the denoising unit may be configured to, for each color component of the isolated point noise pixel, in response to determining that the color component meets the corresponding first predetermined curvature sub-requirement, compensate the value of the color component, such that the surface curvature corresponding to the compensated color component meets the second predetermined curvature sub-requirement corresponding to the color component.

According to some embodiments, for each color component of the plurality of color components, the first predetermined curvature sub-requirement corresponding to the color component may include the surface curvature of the corresponding pixel corresponding to the color component being greater than the predetermined surface curvature threshold corresponding to the color component.

The handling of the collection, storage, usage, processing, transmission, provision and disclosure of the user's personal information involved in the technical solutions of the present disclosure is in compliance with relevant laws and regulations and is not contrary to public order and morals.

According to the embodiments of the present disclosure, there is also provided an electronic device, a readable storage medium, and a computer program product.

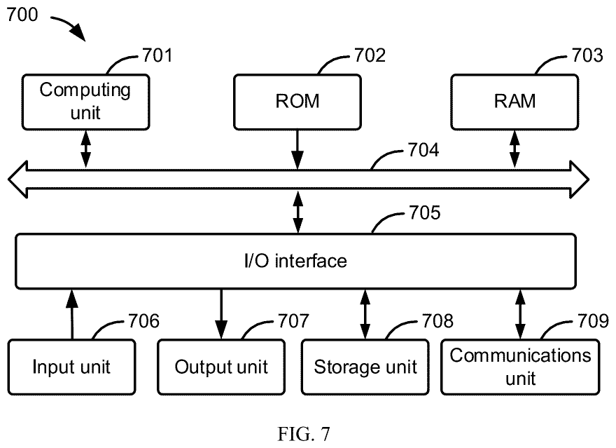

With reference to FIG. 7, a structural block diagram of an electronic device 700 that may serve as a server or client of the present disclosure will now be described, which may be an example of a hardware device that may be applied to various aspects of the present disclosure. The electronic device is intended to represent various forms of digital electronic computer devices, such as, laptops, desktop computers, workstations, personal digital assistants, servers, blade servers, mainframe computers, and other suitable computers. The electronic device may also denote various forms of mobile devices such as, personal digital assistants, cellular phones, smart phones, wearable devices, and other similar computing devices. The components shown herein, their connections and relationships, and their functionality are shown as examples only and are not intended to limit the implementations of the present disclosure described and/or claimed herein.

As shown in FIG. 7, the electronic device 700 includes a computing unit 701, which may perform various appropriate actions and processing according to a computer program stored in a read-only memory (ROM) 702 or a computer program loaded into a random access memory (RAM) 703 from a storage unit 708. In the RAM 703, various programs and data required by the operation of the electronic device 700 may also be stored. The computing unit 701, the ROM 702, and the RAM 703 are connected to each other through a bus 704. Input/output (I/O) interface 705 is also connected to the bus 704.

A plurality of components in the electronic device 700 are connected to a I/O interface 705, including: an input unit 706, an output unit 707, a storage unit 708, and a communication unit 709. The input unit 706 may be any type of device capable of inputting information to the electronic device 700, the input unit 706 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 707 may be any type of device capable of presenting information, and may include, but are not limited to, a display, a speaker, a video/audio output terminal, a vibrator, and/or a printer. The storage unit 708 may include, but is not limited to, a magnetic disk and an optical disk. The communication unit 709 allows the electronic device 700 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth device, a 802.11 device, a WiFi device, a WiMAX device, a cellular communication device, and/or the like.

The computing unit 701 may be a variety of general and/or special purpose processing components with processing and computing capabilities. Some examples of the computing unit 701 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, etc. The computing unit 701 performs the various methods and processes described above, for example, the image processing method. For example, in some embodiments, the image processing method may be implemented as a computer software program tangibly contained in a machine-readable medium, such as the storage unit 708. In some embodiments, part or all of the computer program may be loaded and/or installed onto the electronic device 700 via the ROM 702 and/or the communication unit 709. When the computer program is loaded to the RAM 703 and executed by the computing unit 701, one or more steps of the image processing method described above may be performed. Alternatively, in other embodiments, the computing unit 701 may be configured to perform the image processing method by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form, including acoustic input, voice input, or haptic input.

The systems and techniques described herein may be implemented in a computing system including a back-end component (e.g., as a data server), or a computing system including a middleware component (e.g., an application server), or a computing system including a front-end component (e.g., a user computer with a graphic user interface or a web browser, the user may interact with implementations of the systems and techniques described herein through the graphic user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), and the Internet.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a block chain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed in an order different from that described in the present disclosure. Further, various elements in the embodiments or examples may be combined in various ways. Importantly, with the evolution of the technology, many elements described herein may be replaced by equivalent elements appearing after the present disclosure.

1. A computer-implemented image processing method, comprising:
obtaining an image to be processed, wherein the image to be processed comprises a plurality of pixels;
determining a surface curvature of each pixel of the plurality of pixels; determining, based on a first predetermined curvature requirement, an isolated point noise pixel in the plurality of pixels; and
denoising the isolated point noise pixel.

2. The method according to claim 1, wherein the denoising the isolated point noise pixel comprises:
compensating a pixel value of the isolated point noise pixel, such that the surface curvature of the compensated isolated point noise pixel meets a second predetermined curvature requirement.

3. The method according to claim 2, wherein the second predetermined curvature requirement comprises a surface curvature of the compensated isolated point noise pixel being zero.

4. The method according to claim 1, wherein the first predetermined curvature requirement comprises a surface curvature of the corresponding pixel being greater than a predetermined surface curvature threshold.

5. The method according to claim 1, wherein each pixel of the plurality of pixels comprises a plurality of color components, the surface curvature of each pixel of the plurality of pixels comprises a plurality of surface curvatures corresponding to the plurality of color components respectively, and the first predetermined curvature requirement comprises a plurality of first predetermined curvature sub-requirements corresponding to the plurality of color components respectively,
wherein the determining the isolated point noise pixel in the plurality of pixels comprises:
for each pixel of the plurality of pixels, in response to determining that at least one color component of the pixel meets corresponding first predetermined curvature sub-requirement, determining the pixel as an isolated point noise pixel.

6. The method according to claim 5, wherein the denoising the isolated point noise pixels comprises:
for each color component of the isolated point noise pixel, in response to determining that the color component meets a corresponding first predetermined curvature sub-requirement, compensating the value of the color component, such that a surface curvature corresponding to the compensated color component meets the second predetermined curvature sub-requirement corresponding to the color component.

7. The method according to claim 5, wherein, for each color component of the plurality of color components, the first predetermined curvature sub-requirement corresponding to the color component includes:
the surface curvature corresponding to the color component of a corresponding pixel being greater than a predetermined surface curvature threshold corresponding to the color component.

8. The method according to claim 1, further comprising:
determining a non-isolated point noise pixel in the plurality of pixels; and
enhancing the non-isolated point noise pixels based on the surface curvatures of the non-isolated point noise pixel.

9. The method according to claim 8, wherein the enhancing the non-isolated point noise pixel comprises:
determining a minimum curvature of the non-isolated point noise pixel and a first direction corresponding to the minimum curvature;
determining a curvature contrast based on a curvature of the non-isolated point noise pixel in a second direction perpendicular to the first direction and the minimum curvature;
determining a sharpening intensity for the non-isolated point noise pixel based on the curvature contrast, wherein the sharpening intensity is positively correlated with the curvature contrast; and
enhancing the non-isolated point noise pixel based on the sharpening intensity.

10. The method according to claim 9, wherein the enhancing the non-isolated point noise pixel comprises:
determining a Gaussian mean within the neighborhood of the non-isolated point noise pixel;
determining an intermediate result based on the sharpening intensity and the difference between a pixel value of the non-isolated point noise pixel and the Gaussian mean, wherein the intermediate result is positively correlated with the difference and the intermediate result is positively correlated with the sharpening intensity; and
modifying the pixel value of the non-isolated point noise pixel using the intermediate result, and truncating the modified pixel value to an effective value range.

11. An electronic device, comprising:
one or more processors; and
a memory storing one or more programs configured to be executed by the one or more processors, the one or more programs including instructions for:
obtaining an image to be processed, wherein the image to be processed comprises a plurality of pixels;
determining a surface curvatures of each pixel of the plurality of pixels;
determining, based on a first predetermined curvature requirement, an isolated point noise pixel in the plurality of pixels; and
denoising the isolated point noise pixels.

12. The electronic device according to claim 11, wherein the denoising unit is configured to compensate a pixel value of the isolated point noise pixel such that the surface curvature of the compensated isolated point noise pixel meets a second predetermined curvature requirement.

13. The electronic device according to claim 12, wherein the first predetermined curvature requirement includes a surface curvature of the corresponding pixel being greater than a predetermined surface curvature threshold, and the second predetermined curvature requirement includes a surface curvature of the compensated isolated point noise pixel being zero.

14. The electronic device according to claim 11, wherein each pixel of the plurality of pixels comprises a plurality of color components, the surface curvature of each pixel of the plurality of pixels comprises a plurality of surface curvatures corresponding to the plurality of color components respectively, and the first predetermined curvature requirement includes a plurality of first predetermined curvature sub-requirements corresponding to the plurality of color components respectively,
wherein the determining the isolated point noise pixel in the plurality of pixels comprises:
each pixel of the plurality of pixels, in response to determining that at least one color component of the pixel meets a corresponding first predetermined curvature sub-requirement, determining the pixel as an isolated point noise pixel,
wherein for each color component of the plurality of color components, the first predetermined curvature sub-requirement corresponding to the color component includes:
the surface curvature corresponding to the color component of a corresponding pixel being greater than a predetermined surface curvature threshold corresponding to the color component.

15. The electronic device according to claim 14, wherein denoising the isolated point noise pixels comprises:
for each color component of the isolated point noise pixel, in response to determining that the color component meets a corresponding first predetermined curvature sub-requirement, compensating the value of the color component, such that a surface curvature corresponding to the compensated color component meets the second predetermined curvature sub-requirement corresponding to the color component.

16. The electronic device according to claim 11, the one or more programs further comprise instructions for performing the following operations:
determining a non-isolated point noise pixel in the plurality of pixels; and
enhancing the non-isolated point noise pixel based on the surface curvatures of the non-isolated point noise pixel.

17. The electronic device according to claim 16, wherein the enhancing the non-isolated point noise pixels comprises:
determining a minimum curvature of the non-isolated point noise pixel and a first direction corresponding to the minimum curvature;
determining a curvature contrast based on a curvature of the non-isolated point noise pixel in a second direction perpendicular to the first direction and the minimum curvature;
determining a sharpening intensity for the non-isolated point noise pixel based on the curvature contrast, wherein the sharpening intensity is positively correlated with the curvature contrast; and
enhancing the non-isolated point noise pixel based on the sharpening intensity.

18.-20. (canceled)

21. A non-transient computer-readable storage medium storing one or more programs, the one or more programs comprising instructions, which when executed by one or more processors of an electronic device, cause the electronic device to:
obtain an image to be processed, where the image to be processed comprises a plurality of pixels;
determine a surface curvature of each pixel of the plurality of pixels;
determine, based on a first predetermined curvature requirement, an isolated point noise pixel in the plurality of pixels; and
denoise the isolated point noise pixel.

22. The electronic device according to claim 17, wherein the enhancing the non-isolated point noise pixel comprises:
determining a Gaussian mean value within the neighborhood of the non-isolated point noise pixel;
determining an intermediate result based on the sharpening intensity and the difference between a pixel value of the non-isolated point noise pixel and the Gaussian mean value, wherein the intermediate result is positively correlated with the difference value and the intermediate result is positively correlated with the sharpening intensity; and
modifying the pixel value of the non-isolated point noise pixel using the intermediate result and truncating the modified pixel value to an effective value range.
